(19) United States
(12) Patent Application Publication
(10) Pub. No.: US 2011/0015772 A1
(43) Pub. Date: Jan. 20, 2011

(54) Measurement System

(76) Inventor: Mario A. Salazar, Colorado Springs, CO (US)

Correspondence Address: Mark G. Pannell, 2044 Coldstone Way, Colorado Springs, CO, 80921, US

(21) Appl. No.: 12/835,829

(22) Filed: Jul. 14, 2010

Related U.S. Application Data
(60) Provisional application No. 61/225,429, filed on Jul. 14, 2009.

(51) Int. Cl. G06F 17/50; G01B 5/00; G06F 15/00

(52) U.S. Cl. 700/97; 702/155; 700/160

(57) ABSTRACT

A measurement and workpiece cutting system is disclosed. The measurement and workpiece cutting system has a physical dimension measuring apparatus and a cutting apparatus. The physical dimension measuring apparatus has a physical dimension measuring unit and a transmitter. The physical dimension measuring apparatus measures a physical dimension for a workpiece to be cut. The transmitter transmits either information representative of the measured physical dimension or cutting dimensions. A processing unit is configured to calculate cutting dimensions from the information representative of the physical dimension. The cutting apparatus has a cutting mechanism for cutting the workpiece, a receiver for receiving either information representative of the measured physical dimension or cutting dimensions, a data storage unit, a display, and a physical dimension control for setting the cutting mechanism to cut the workpiece to the cutting dimensions.

This application claims the benefit of U.S. Provisional Application No. 61/225,429 filed Jul. 14, 2009.

### BACKGROUND OF THE INVENTION

Working with wood and other types of workpieces usually requires a sequence of measuring and cutting. The target size or angle is measured and then the cutting machine is set to cut the workpiece to the target size or angle. This process allows for human fallibility to cause errors in the final size or angle of the workpiece, either by misreading the measuring device, miscommunication of the information, or incorrectly setting the cutting device.

### BRIEF DESCRIPTION OF THE SEVERAL VIEWS OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the accompanying drawings in which:

FIG. 1 is a block diagram of one embodiment of the measurement and workpiece cutting system of the present invention.

FIG. 2 is a perspective view of one embodiment of the physical dimension measuring apparatus of the present invention.

FIG. 3 is a perspective view of a rotatable magnetic shaft bearing assembly.

FIG. 4 is an exploded view of the rotatable magnetic shaft bearing assembly of FIG. 3.

FIG. 5 is a diagram of one embodiment of a pin type replaceable tip extender.

FIG. 6 is a diagram of one embodiment of a marking adapter type replaceable tip extender.

FIG. 7 is a diagram of one embodiment of a caliper insert type replaceable tip extender.

### DETAILED DESCRIPTION OF THE INVENTION

As required, a detailed illustrative embodiment of the present invention is disclosed herein. However, techniques, systems, and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of the preferred embodiment (as well as some alternative embodiments) of the present invention.

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

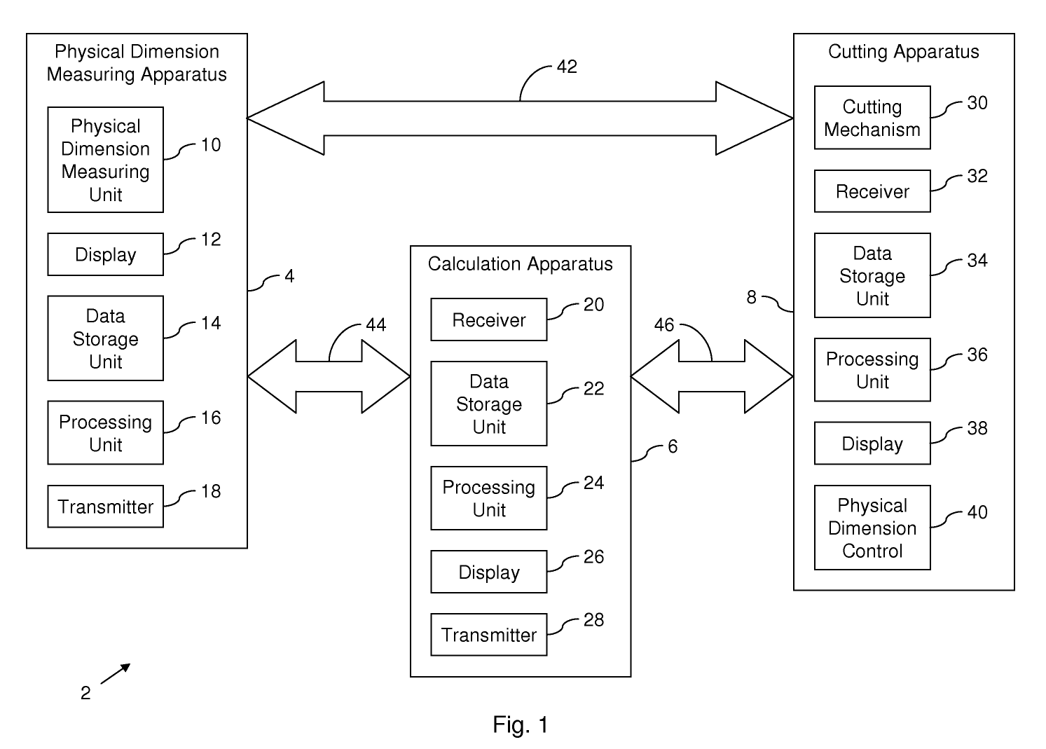

FIG. 1 illustrates, in block diagram form, one or more embodiments of the measurement and workpiece cutting system 2 of the present invention. The measurement and workpiece cutting system 2 of the present invention includes a physical dimension measuring apparatus 4, a cutting apparatus 6, and a calculation apparatus 8.

Physical dimension measuring apparatus 4 is an apparatus for measuring a physical dimension and transmitting either information representative of the physical dimension or a cutting dimension. In order to arrive at the cutting dimension, a measured physical dimension may need to first be processed. In one embodiment, physical dimension measuring apparatus 4 includes a physical dimension measuring unit 10, a display 12, a data storage unit 14, a processing unit 16, and a transmitter 18.

Physical dimension measuring unit 10 is any device for measuring a physical dimension for a workpiece (not shown) to be cut. The physical dimension may be any physical dimension such as an angle or a size, such as a height, width, length, or depth. Physical dimension measuring unit 10 may be any known or later developed technology for measuring sizes, such as a protractor, calipers, depth gauge, or tape measure, as long as the device is able to communicate the measured dimension to the other elements of the physical dimension measuring apparatus 4.

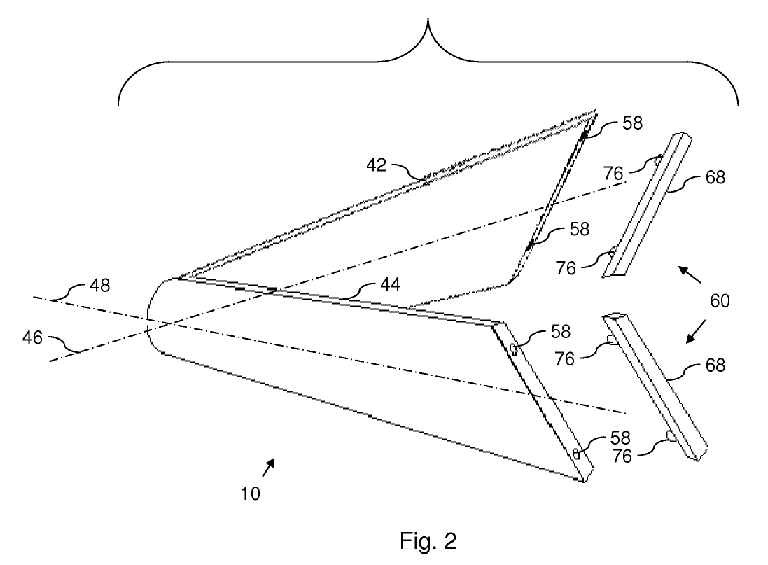

FIG. 2 illustrates one embodiment of physical dimension measuring apparatus 4. Physical dimension measuring apparatus 4 has first 42 and second 44 arms. Each arm 42,44 has a longitudinal axis 46,48. The arms 42,44 are rotatably interconnected at one end. In one embodiment, arms 42, 44 are rotatably interconnected by a rotatable magnetic shaft bearing assembly 50.

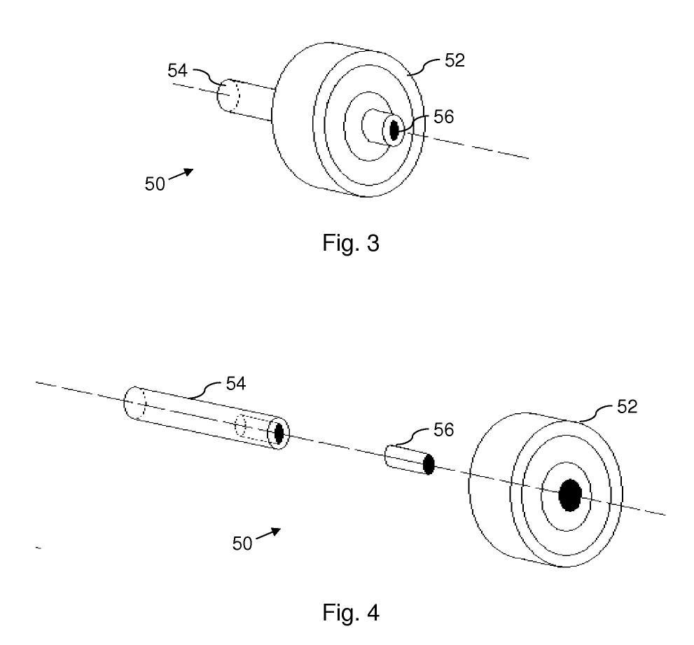

FIGS. 3 and 4 illustrate one embodiment of rotatable magnetic shaft bearing assembly 50. Rotatable magnetic shaft bearing assembly 50 has a bearing 52, a shaft 54, and a magnet 56. Bearing 50 is affixed to first arm 42. Shaft 54 is affixed to second arm 44 and disposed in bearing 50. Magnet 56 is embedded in shaft 54 within bearing 52. Physical dimension measuring apparatus 4 is equipped with a unique rotating magnetic shaft bearing assembly 50 that facilitates full 360° angular measurements. The assembly 50 has magnet 56 embedded in shaft 54 that is pressed into bearing 50, enabling shaft 54 and magnet 56 to rotate a full 360°. Physical dimension measuring apparatus 4 determines angular measurements by analyzing (via electronic sensor that resides over magnet 56 portion of shaft 54) the position of shaft 54 relative to the fixed portion (outer ring) of bearing 50.

A magnetic field sensor (not shown) is disposed near magnet 56. The magnetic field sensor is configured to output an angle signal indicative of the angle between the longitudinal axes 46, 48 of the first 42 and second 44 arms. An interpretation unit (not shown) is configured to calculate the physical dimension for a workpiece to be cut from the angle signal.

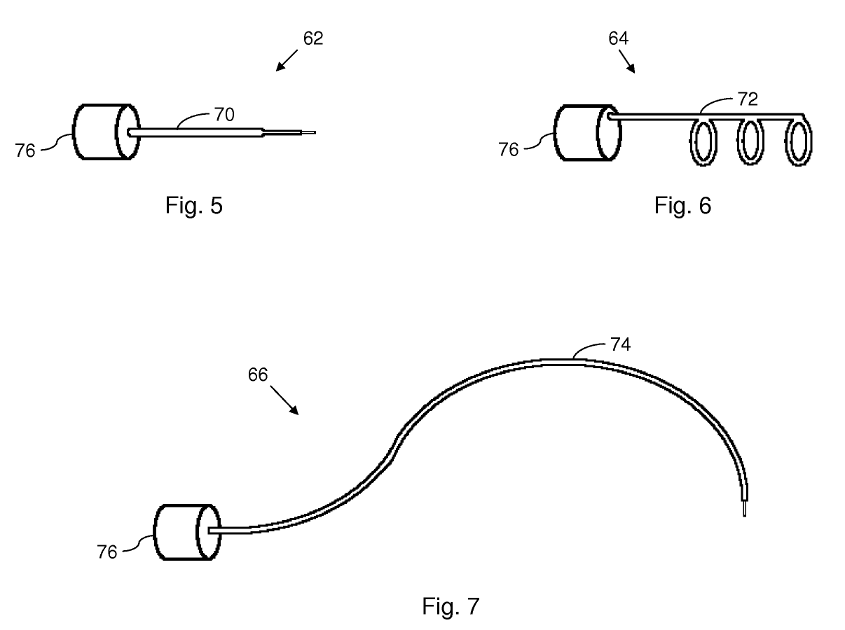

Referring again to FIG. 2, in one embodiment, an electrically conductive jack 58 is disposed at the distal end of each arm 42, 44. Jack 58 is for use with tip extenders 60, 62, 64, 66. FIGS. 2 and 5-7 illustrate examples of tip extenders 60, 62, 64, 66 for use with physical dimension measuring apparatus 4. Each tip extender has a functional tip 68, 70, 72, 74 and an electrically conductive plug 76. Electrically conductive plug 76 is configured to mate with jack 58 and uniquely identify the functional tip 68, 70, 72, 74 to physical dimension measuring apparatus 4.

Tip extenders in a variety of sizes and shapes adapt physical dimension measuring apparatus 4 automatically for functions other than the measurement of angles. As a tip extender is attached, physical dimension measuring apparatus 4 will sense the tip type and change the internal configuration so that physical dimension measuring apparatus 4 will operate to the predetermined function for that tip. The tip extenders allow size as well as angular measurements. The use of the physical dimension measuring apparatus 4 as a compass, or as a caliper is dependent on the tip inserted. Multiple sense points are within jack 58 to provide an electronic key for physical dimension measuring apparatus 4 to decipher and choose the appropriate function. The electronic key is a combination of resistance and contacts that are sensed and interpreted by physical dimension measuring apparatus 4.

Tip extender 60 is a precision end plate. Replaceable, precision tip plates 60 provide an accurate reference for a height measurement. Plates 60 are also replaceable as a protection to physical dimension measuring apparatus 4. If apparatus 4 is dropped, damaged plates 60 are easily removed and changed without affecting the overall performance.

Tip extender 62 is a pin or spike for use as a reference point. Tip extender 64 is a marking adapter for holding a pen or pencil so that physical dimension measuring apparatus 4 may function as a compass. Tip extender 66 is a caliper extension so that physical dimension measuring apparatus 4 may function as insider or outside calipers.

In one embodiment, calculation apparatus 8 has a receiver 20, a data storage unit 22, a processing unit 24, a display 26, and a transmitter 28. Calculation apparatus may be a separate unit, as show, or embodied within physical dimension measuring apparatus or cutting apparatus.

In one embodiment, cutting apparatus 6 includes a cutting mechanism 30, a receiver 32, a data storage unit 34, a processing unit 36, a display 38, and a physical dimension control 40. Cutting mechanism 30 is any mechanism for cutting the workpiece. Examples of cutting mechanisms 30 include miter saws, table saws, band saws, and drill bits.

Physical dimension control 40 is any device for setting cutting mechanism 30 to cut the workpiece to the displayed cutting dimensions. Examples of physical dimension controls 40 include bevel and miter settings on a miter saw; miter, angle, and fence settings for a table saw; and depth and diameter settings for a drill or drill press.

Data storage unit 14, 22, 34 retains information representative of the physical dimension or a cutting dimension. Data storage unit 14, 22, 34 is any device or system configured to store data. Data storage unit 14, 22, 34 may be any type of storage media such as magnetic, optical, or electronic storage media. Data storage unit 14, 22, 34 is illustrated in FIG. 1 as a single device. Alternatively, data storage unit 14, 22, 34 may include more than one device. Furthermore, each device of data storage unit 14, 22, 34 may be embodied in a different media type. For example, one device of data storage unit 14, 22, 34 may be a magnetic storage media while another device of data storage unit 14, 22, 34 is an electronic storage media. Other examples of types of media include mechanical, biological, and organic.

Processing unit 16, 24, 36 is configured to calculate cutting dimensions from the information representative of the physical dimension received from physical dimension measuring apparatus 4.

Display 12, 26, 38 allows a user to selectively view information representative of the physical dimension or a cutting dimension. Display 12, 26, 38 may be any type of display. Example of types of displays include LED, LCD, plasma, and CRT displays.

Transmitters 18, 28 are used to transmit data or information. Any known or later developed technology may be used as transmitter 18, 28. Receivers 20, 32 receive information representative of the physical dimension or cutting dimension from transmitters 18, 28. Any known or later developed technology may be used as receivers 20, 32.

Measurement and workpiece cutting system 2 is capable of communicating instructions, data, and memory to or from a variety of definable tools and communication and processing devices. Examples of uses include but are not limited to: a protractor that takes measurements and transmits them to a saw equipped with a visible digital display of the data; a laptop can request a measurement from the measuring device and provide it to a designated tool; a measurement of an angle, stored, used for trig calculation and stored, then another operator/tool later recalls the needed information previously captured.

Measurement and workpiece cutting system 2 includes an physical dimension measuring apparatus 4 equipped with a rotary sensor designed to output a signal to an electronic module that processes the data, stores it, and communicates it via visual display, auditory, wireless, or hardwired methods to other tools and devices similarly equipped to receive, transmit, and interpret the data.

The foregoing description is only illustrative of the invention and not intended to be exhaustive or to limit the invention to the precise forms disclosed. Various alternatives and modifications can be devised by those skilled in the art without departing from the invention. Accordingly, the present invention embraces all such alternatives, modifications, and variances that fall within the scope of the appended claims.

What is claimed is:

1. A measurement and workpiece cutting system comprising:
a physical dimension measuring apparatus having
a physical dimension measuring unit for measuring a physical dimension for a workpiece to be cut,
a processing unit configured to calculate cutting dimensions from the physical dimension for a workpiece to be cut, and
a transmitter configured to transmit the cutting dimensions; and
a cutting apparatus having
a cutting mechanism for cutting the workpiece,
a receiver for receiving the cutting dimensions from the calculation apparatus,
a data storage unit for retaining the cutting dimensions received from the calculation apparatus,
a display for selectively displaying, from the data storage unit, the cutting dimensions, and
a physical dimension control for setting the cutting mechanism to cut the workpiece to the displayed cutting dimensions.

2. The measurement system of claim 1 wherein the physical dimension for a workpiece to be cut is an angle for a workpiece to be cut.

3. The measurement system of claim 1 wherein the physical dimension for a workpiece to be cut is a size for a workpiece to be cut.

4. The measurement system of claim 1 wherein the physical dimension measuring unit includes:
first and second arms, each arm having a longitudinal axis;
a rotatable magnetic shaft bearing assembly having
a bearing affixed to the first arm,
a shaft affixed to the second arm and disposed in the bearing,
a magnet embedded in the shaft within the bearing;
a magnetic field sensor disposed near the magnet and configured to output an angle signal indicative of the angle between the longitudinal axis of the first and second arms; and
an interpretation unit configured to calculate the physical dimension for a workpiece to be cut from the angle signal.

5. The measurement system of claim 1 wherein the physical dimension measuring unit includes:
first and second arms, each having proximal and distal ends, the proximal ends rotatably interconnected;
an electrically conductive jack disposed at the distal end of each arm; and
a tip extension having
a functional tip and
an electrically conductive plug configured to mate with the jack and uniquely identify the functional tip to the physical dimension measuring unit.

6. The measurement system of claim 5 wherein the functional tip includes a tip plate.

7. The measurement system of claim 5 wherein the functional tip includes a caliper extension.

8. A measurement and workpiece cutting system comprising:
a physical dimension measuring apparatus having
a physical dimension measuring unit for measuring a physical dimension for a workpiece to be cut and
a transmitter configured to transmit information representative of a physical dimension measured by the physical dimension measuring unit;
a calculation apparatus having
a receiver for receiving the information representative of the physical dimension from the physical dimension measuring apparatus,
a processing unit configured to calculate cutting dimensions from the information representative of the physical dimension received from the physical dimension measuring apparatus, and
a transmitter configured to transmit the cutting dimensions; and
a cutting apparatus having
a cutting mechanism for cutting the workpiece,
a receiver for receiving the cutting dimensions from the calculation apparatus,
a data storage unit for retaining the cutting dimensions received from the calculation apparatus,
a display for selectively displaying the cutting dimensions from the data storage unit, and
a physical dimension control for setting the cutting mechanism to cut the workpiece to the displayed cutting dimensions.

9. The measurement system of claim 8 wherein the physical dimension for a workpiece to be cut is an angle for a workpiece to be cut.

10. The measurement system of claim 8 wherein the physical dimension for a workpiece to be cut is a size for a workpiece to be cut.

11. The measurement system of claim 8 wherein the physical dimension measuring unit includes:
first and second arms, each arm having a longitudinal axis;
a rotatable magnetic shaft bearing assembly having
a bearing affixed to the first arm,
a shaft affixed to the second arm and disposed in the bearing,
a magnet embedded in the shaft within the bearing;
a magnetic field sensor disposed near the magnet and configured to output an angle signal indicative of the angle between the longitudinal axis of the first and second arms; and
an interpretation unit configured to calculate the physical dimension for a workpiece to be cut from the angle signal.

12. The measurement system of claim 11 wherein the physical dimension measuring unit includes:
first and second arms, each having proximal and distal ends, the proximal ends rotatably interconnected;
an electrically conductive jack disposed at the distal end of each arm; and
a tip extension having
a functional tip and
an electrically conductive plug configured to mate with the jack and uniquely identify the functional tip to the physical dimension measuring unit.

13. The measurement system of claim 11 wherein the functional tip includes a tip plate.

14. The measurement system of claim 11 wherein the functional tip includes a caliper extension.

15. A measurement and workpiece cutting system comprising:
a physical dimension measuring apparatus having
a physical dimension measuring unit for measuring a physical dimension for a workpiece to be cut and
a transmitter configured to transmit information representative of a physical dimension measured by the physical dimension measuring unit and
a cutting apparatus having
a cutting mechanism for cutting the workpiece,
a receiver for receiving the information representative of the physical dimension from the physical dimension measuring apparatus,
a data storage unit for retaining the information representative of the physical dimension received from the physical dimension measuring apparatus,
a processing unit configured to calculate cutting dimensions from the information representative of the physical dimension received from the physical dimension measuring apparatus,
a display for selectively displaying the cutting dimensions, and
a physical dimension control for setting the cutting mechanism to cut the workpiece to the displayed cutting dimensions.

16. The measurement system of claim 15 wherein the physical dimension for a workpiece to be cut is an angle for a workpiece to be cut.

17. The measurement system of claim 15 wherein the physical dimension for a workpiece to be cut is a size for a workpiece to be cut.

18. The measurement system of claim 15 wherein the physical dimension measuring unit includes:
first and second arms, each arm having a longitudinal axis;
a rotatable magnetic shaft bearing assembly having
a bearing affixed to the first arm,
a shaft affixed to the second arm and disposed in the bearing,
a magnet embedded in the shaft within the bearing;
a magnetic field sensor disposed near the magnet and configured to output an angle signal indicative of the angle between the longitudinal axis of the first and second arms; and
an interpretation unit configured to calculate the physical dimension for a workpiece to be cut from the angle signal.

19. The measurement system of claim 15 wherein the physical dimension measuring unit includes:
first and second arms, each having proximal and distal ends, the proximal ends rotatably interconnected;
an electrically conductive jack disposed at the distal end of each arm; and
a tip extension having
a functional tip and
an electrically conductive plug configured to mate with the jack and uniquely identify the functional tip to the physical dimension measuring unit.

20. The measurement system of claim 19 wherein the functional tip includes a tip plate.
